(19) United States
(12) Patent Application Publication
(10) Pub. No.: US 2026/0155566 A1
(43) Pub. Date: Jun. 4, 2026

(54) RECONFIGURABLE HUYGENS' REFRACTORS BASED ON MATERIAL TUNING

(71) Applicant: Dell Products L.P., Round Rock, TX (US)

(72) Inventors: Keigan Macdonell, Ottawa (CA); David Fernando Hardy, Ottawa (CA); Shulabh Gupta, Ottawa (CA); Tejinder Singh, Manotick (CA); Navjot Kaur Khaira, Manotick (CA)

(21) Appl. No.: 18/968,912

(22) Filed: Dec. 4, 2024

(51) Int. Cl. H01Q 3/34; H01P 7/00; H01Q 3/26

(52) U.S. Cl. CPC H01Q 3/34; H01P 7/00; H01Q 3/2676

(57) ABSTRACT

The technology described herein is directed towards reconfigurable Huygens'refractors, which when implemented as unit cells of a metasurface that receives incoming millimeter wave signals, results in transmitted millimeter wave beams that can be beamformed via unit cell reconfiguration. A sufficiently large phase range is achieved by varying the refractive index of the dielectric between the resonating elements of a unit cell. The unit cells' phases can be individually reconfigured based on external stimuli, such as thermal energy, mechanical energy, electrical energy and/or optical energy, whereby different phase profiles of the metasurface can be dynamically configured to transmit a beamformed beam based on the metasurface's currently configured phase profile. The metasurface can be substantially optically transparent in some implementations.

### BACKGROUND

Radio frequency (RF) signals in the millimeter-wave (mm-wave) band (28-110 gigahertz, including the Ka, V, and W bands) and beyond will deliver the high data rates and throughput of next-generation wireless communication networks. A major disadvantage of mm-wave wireless links is their sharp path loss due to physical obstacles, including materials constituting common structures found in urban or indoor environments, which absorb and scatter such high-frequency radio waves.

### BRIEF DESCRIPTION OF THE DRAWINGS

The technology described herein is illustrated by way of example and not limited in the accompanying figures in which like reference numerals indicate similar elements and in which:

FIG. 1 is a two-dimensional (2D) representation of an example metasurface layout of reconfigurable unit cells based on Huygens' refractors, including an enlarged unit cell, in accordance with various example embodiments and implementations of the subject disclosure.

FIG. 2 is a three-dimensional (3D) representation of the example hexagonally-shaped reconfigurable unit cell of FIG. 1, in accordance with various example embodiments and implementations of the subject disclosure.

FIGS. 3A, 3B, 4A, 4B, 5A, 5B, 6A and 6B are representations of reconfiguring the unit cell(s) of a metasurface based on thermal energy, mechanical energy, electrical energy, and optical energy, respectively, in accordance with various example embodiments and implementations of the subject disclosure.

FIG. 7 is a 3D representation of an example unit cell structure with an assigned Floquet boundary for simulation, in accordance with various example embodiments and implementations of the subject disclosure.

FIG. 8 is a graphical representation of example phase response showing reconfigurability of the unit cells, in accordance with various example embodiments and implementations of the subject disclosure.

FIG. 9 is a graphical representation of example magnitude response showing reconfigurability of the unit cells, in accordance with various example embodiments and implementations of the subject disclosure.

FIG. 10 is a flow diagram showing example operations related to reconfiguring a metasurface based on applying stimuli to the metasurface's unit cells, in accordance with various example embodiments and implementations of the subject disclosure.

### DETAILED DESCRIPTION

The technology described is generally directed towards a reconfigurable Huygens' metasurface for millimeter-wave (mm-wave) beamforming. By dynamically adjusting the refractive index of the dielectric material, the metasurface, which can be substantially optically transparent, achieves real-time transmission phase control and beam steering, while minimizing back-reflection.

In general, metasurfaces (sometimes referred to as reconfigurable intelligent surfaces) are a generally two-dimensional synthetic structure, having electromagnetic (EM) scattering properties that can be finely tuned to achieve anomalous redirection (reflection or refraction/transmission) of wireless signals. A Huygens' metasurface includes an array of resonant structures (unit cells) that are sub-wavelength in periodicity, such that by modulating the scattered magnitude and phase on a per-unit cell basis, a near-continuous complex reflectivity and transmittivity profile can be achieved. Such Huygens' metasurfaces are built with a dielectric substrate that is sandwiched between metallic patches; a feed antenna is used to illuminate the metasurface and the refracting elements steer the incident radiation into a particular direction. Each unit cell's dielectric material's properties (e.g., its refractive index/permittivity) can be controllably altered, including dynamically reconfigured (tuned) as described herein, to achieve a certain phase distribution across the metasurface, which will then cause constructive interference such that the incident radiation is retransmitted (refracted) in a particular direction. Thus, through establishing phase gradients/a phase profile, for example, the main lobe of the scattered field can be efficiently steered (beamformed) towards a desired target in transmission.

It should be understood that any of the examples herein are non-limiting. Thus, any of the embodiments, aspects, concepts, structures, functionalities or examples described herein are non-limiting, and the technology may be used in various ways that provide benefits and advantages in communications and wireless technology in general. It also should be noted that terms used herein, such as “optimize” or “optimal” and the like only represent objectives to move towards a more optimal state, rather than necessarily obtaining ideal results.

Reference throughout this specification to “one embodiment,” “an embodiment,” “one implementation,” “an implementation,” etc. means that a particular feature, structure, or characteristic described in connection with the embodiment/implementation can be included in at least one embodiment/implementation. Thus, the appearances of such a phrase “in one embodiment,” “in an implementation,” etc. in various places throughout this specification are not necessarily all referring to the same embodiment/implementation. Furthermore, the particular features, structures, or characteristics may be combined in any suitable manner in one or more embodiments/implementations. It also should be noted that terms used herein, such as “optimize,” “optimization,” “optimal,” “optimally” and the like only represent objectives to move towards a more optimal state, rather than necessarily obtaining ideal results. For example, “optimal” placement of a subnet means selecting a more optimal subnet over another option, rather than necessarily achieving an optimal result. Similarly, “maximize” means moving towards a maximal state (e.g., up to some processing capacity limit), not necessarily achieving such a state.

Further, it is to be understood that the present disclosure will be described in terms of a given illustrative architecture; however, other architectures, structures, substrate materials and process features, and steps can be varied within the scope of the present disclosure.

It will also be understood that when an element such as a layer, region or substrate is referred to as being “on” or “over” “atop” “above” “beneath” “below” and so forth with respect to another element, it can be directly on the other element or intervening elements can also be present. In contrast, only if and when an element is referred to as being “directly on” or “directly over” another element, are there no intervening element(s) present. Note that orientation is generally relative; e.g., “on” or “over” can be flipped, and if so, can be considered unchanged, even if technically appearing to be under or below/beneath when represented in a flipped orientation. It will also be understood that when an element is referred to as being “connected” or “coupled” to another element, it can be directly connected or coupled to the other element or intervening elements can be present. In contrast, only if and when an element is referred to as being “directly connected” or “directly coupled” to another element, are there no intervening element(s) present.

The following detailed description is merely illustrative and is not intended to limit embodiments and/or application or uses of embodiments. Furthermore, there is no intention to be bound by any expressed or implied information presented in the preceding sections, or in the Detailed Description section.

One or more example embodiments of the subject disclosure will now be described more fully hereinafter with reference to the accompanying drawings in which example components, graphs and/or operations are shown. In the following description, for purposes of explanation, numerous specific details are set forth in order to provide a more thorough understanding of the various embodiments. However, the subject disclosure may be embodied in many different forms and should not be construed as limited to the examples set forth herein.

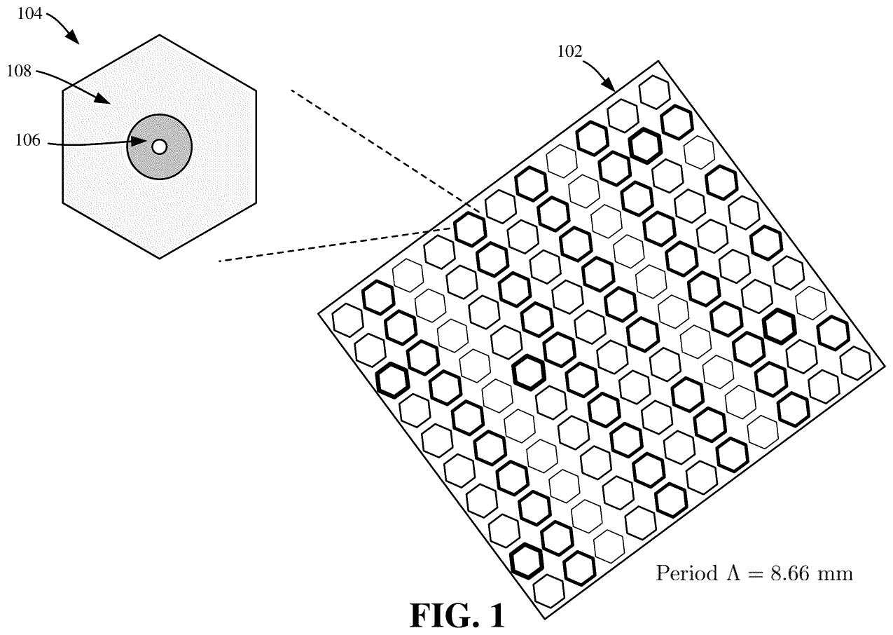

FIG. 1 shows a generalized representation of an example metasurface 102 arranged as an array of reconfigurable Huygens' refractors, (not showing the resonating elements), including a hexagonally-shaped group of unit cells. While the unit cells are shown as hexagonally-shaped in FIG. 1, this is a nonlimiting example, and any suitable shape can be used, typically, but not necessarily, regular polygons of the same shape. The metasurface 102 can be dynamic, meaning that the metasurface can be reconfigured to a defined phase profile as needed.

Note that like the unit cells, the overall rectangular shape of the metasurface 102 in FIG. 1 is only one arbitrary, nonlimiting example, as any metasurface shape can be used as long as the shape results in a resonating surface that resonates to reflect the incoming electromagnetic wave at the desired design frequency with the defined phase profile. Further note that while 11×10 unit cells are shown distributed with a period of 8.366 millimeters (mm), this is also a nonlimiting example, as any practical number of unit cells of any practical size can be used with any practical size metasurface and periodic; indeed, the surface 102 depicted in FIG. 1 can be considered a portion of a larger surface with more unit cells. Thus, the numbers of (unit cells) and their sizes relative to the surface (which also can be of different dimensions) are not intended to be representative of actual numbers and sizes, and are only depicted for purposes of explanation and not intended to convey relative numbers or sizes. Indeed, in any of the drawing figures herein, the relative sizes, data results shown in the graphs or anything else shown are only presented for purposes of explanation.

One unit cell 104 of the group of unit cells of the static surface is shown in FIG. 1 enlarged relative to the depicted example static metasurface 102. In this enlarged view, elliptically-shaped metallic resonators (the upper resonating element 106 is depicted). Notwithstanding, this is only one example, and any resonator structure such as square, rectangular, circular, hexagonal and so on may be used, as long as the resonating metallic resonators resonate at or relatively close to the designed frequency. Also shown in the enlarged view of the unit cell 104 is a dielectric material 108.

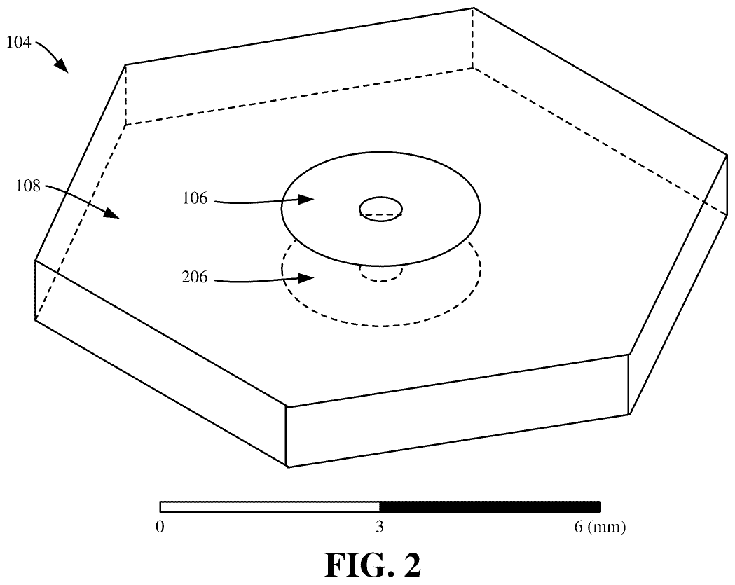

FIG. 2 shows a three-dimensional (3D) view of the unit cell 104 (e.g., of FIG. 1) for a Huygen's metasurface. There are many known examples of transmissive-type metasurfaces; one such type is the Huygen's metasurface, whose unit cell 104 includes (at a minimum) a pair of metallic, planar resonators 106 (upper) and 206 (lower) separated by the dielectric substrate 108. The resonators 106 and 206 experience coupled magnetic and electric resonant modes when excited by an incident field; the adjacency of these resonant modes in the frequency domain has a cancelling effect on the backwards-propagating (i.e. reflected) scattered field, thereby facilitating near complete transmission. Through designed tuning of the resonant structures, an arbitrary transmitted phase can be achieved, whereby across the metasurface a phase gradient is established, which affords beam forming (including steering) in accordance with the generalized Snell's Law theorem.

To summarize thus far, described herein is a Huygens' metasurface, which optionally can be developed on optically transparent substrate. In general, Huygens' metasurfaces are refractor structures that beamform incoming waves (of the design frequency) impinging on the surface on the transmission side. For maximum beam-forming efficiency, Huygens' metasurface are designed to suppress back-reflection and create specific magnitude and phase profiles across the surface to achieve desired beamformed patterns. A Huygen's metasurfaces achieve zero or minimal back reflection as a result of interaction between two collocated electric and magnetic resonances. Zero or near-zero backscattering conditions are obtained when a fine balance is achieved between the strengths of these two resonances. In addition, these two resonances control the transmission phase, which is a significant design parameter for transmission beamforming. Therefore, to achieve a wide range of transmission phase (ideally with 360-degree coverage) while being simultaneously matched, the two electric and magnetic resonances are simultaneously controlled. For a static surface, this can be achieved using varied geometry of the resonating particles. However, such a functionality has been challenging to achieve in real-time.

Described herein is tuning the transmission phase of a Huygen's metasurface based on tuning refractive index of the materials, while preserving the matching properties of the surface. The resulting reconfigurable metasurface is based on intrinsic material tuning, thus making it easily scalable to mmWave (and beyond) frequency implementations.

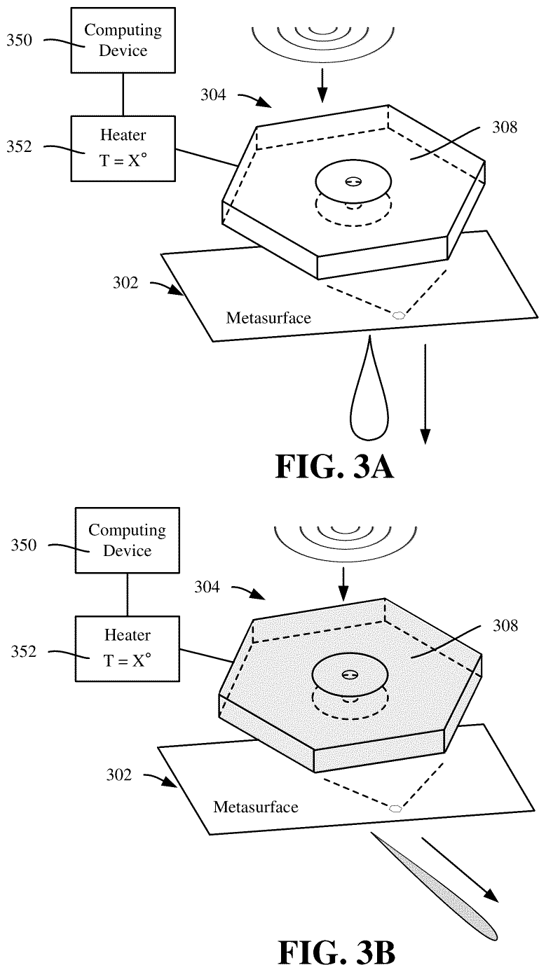

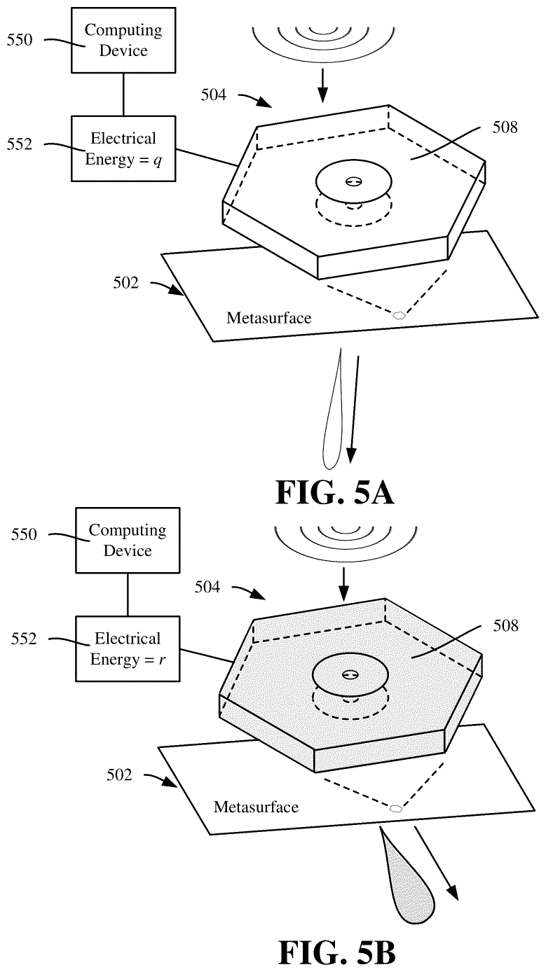

As shown in FIGS. 3A-6B, the material's refractive index may be tuned based on thermal energy, mechanical energy/force (to stress/train the dielectric material) electrical energy, optical energy (for an optically active dielectric), respectively, or any other suitable stimulus/combination thereof, for instance. This can be used to engineer the Huygens' particle response and the subsequent transmission beamforming in real-time; for example, in FIG. 3A, heat (e.g., applied evenly) can change the refractive index of a suitable dielectric 308, and thereby the change the unit cell's transmitted instance (phase change) of the incoming planar wave. When constructively interfering with the transmitted instances from other cells according to a defined profile, e.g., with thermal energy applied to the individual unit cells independently as controlled by a computing device 350 (such as a controller) to a heater 352, beamforming results. In the example of FIG. 3A, the temperature of X° is applied to the unit cell 304 as part a first metasurface phase profile, by which the metasurface 302 beamforms a resultant wider beam in one direction. At a later time, the temperature of Y° is applied to the unit cell 304 as part of a second, different metasurface phase profile, by which the metasurface 302 beamforms a resultant narrower beam in a different direction, as represented in FIG. 5B.

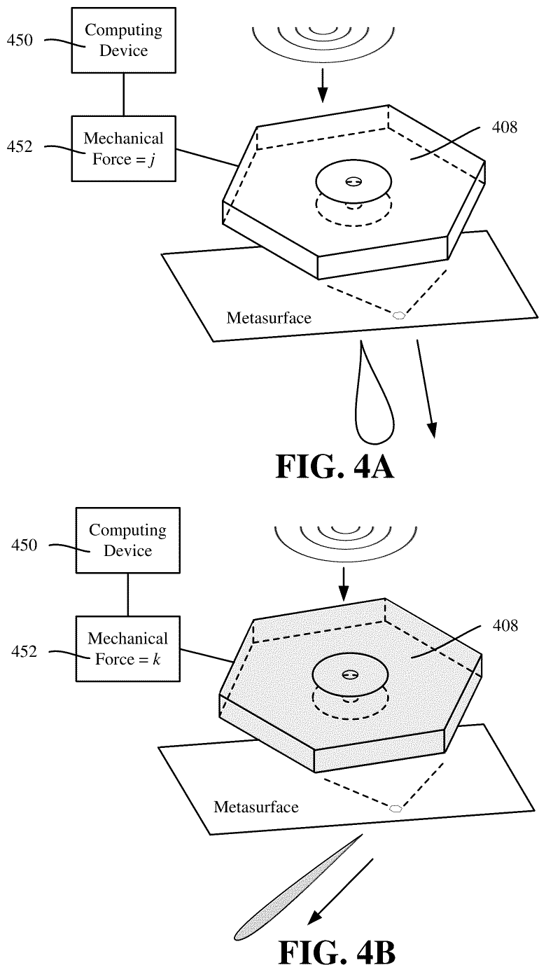

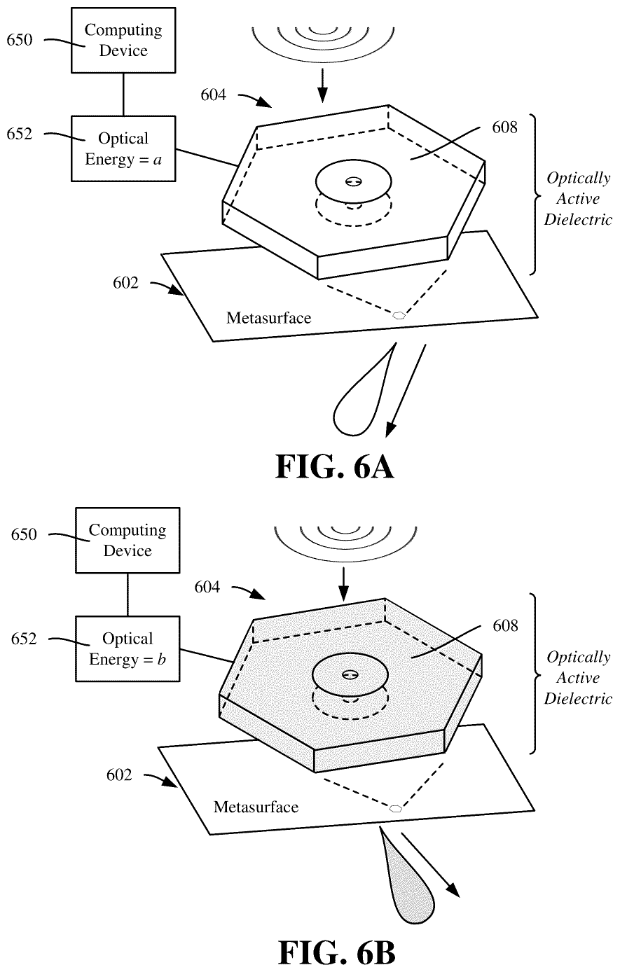

In FIGS. 4A-6B, components corresponding to those labeled 3xx in FIG. 3 are labeled 4xx-6xx, respectively. FIGS. 4A and 4B show similar examples for mechanical force, and FIGS. 5A and 5B show similar examples for electrical energy; thin metal bias lines can bring in electrical current (e.g., direct current). Note that the material property can be changed electronically to lead to a similar effect; for example, the patches could be made using graphene which may be useful for added tunability in the future. For an optically active dielectric material 608, different optical energy can be applied to change the dielectric material's refractive index, as represented in FIGS. 6A and 6B.

Thus, one Huygens' unit cell structure, such as one that includes electromagnetically coupled elliptically shaped particles, facilitates optimally balanced electric and magnetic resonances for varying material refractive index values (for minimal back-scattering). More particularly, the technology described herein utilizes Huygens' metasurface designed for mm-wave beamforming; the metasurface can be substantially optically transparent. The dielectric's refractive index, and thus its permittivity, can be dynamically tuned using stimuli such as electrical, thermal, or mechanical control. This tuning alters the transmission phase of incident waves, enabling real-time control of beam direction.

The Huygens' metasurface achieves minimal backscattering by balancing the electric and magnetic resonances within the unit cell, which is needed for maintaining transmission efficiency. Through material tuning, a wide range of phase control (greater than 360 degrees) is achieved, allowing the metasurface to steer beams effectively without relying on off-the-shelf electronic components. This reconfigurable approach ensures high transmission and low reflection, making it suitable for integration into mm-wave communication networks in urban and indoor environments. In implemented as a substantially transparent metasurface, the transparency of the metasurface further enhances its practical applicability, allowing it to be deployed on windows or other surfaces without obstructing visibility.

Returning to the example unit cell geometry shown in FIGS. 2 and 3, that is, in the form of the hexagonal unit cell 104 where two elliptically-shaped metallic patches 106 and 206 are printed on each side of a thin dielectric material 108, the dielectric material 108 has a certain refractive index, n (or a permittivity ϵᵣ). Such a unit cell is in an infinitely periodic environment to emulate surface. A plane-wave is incident on one side, and the reflected and transmitted waves are observed.

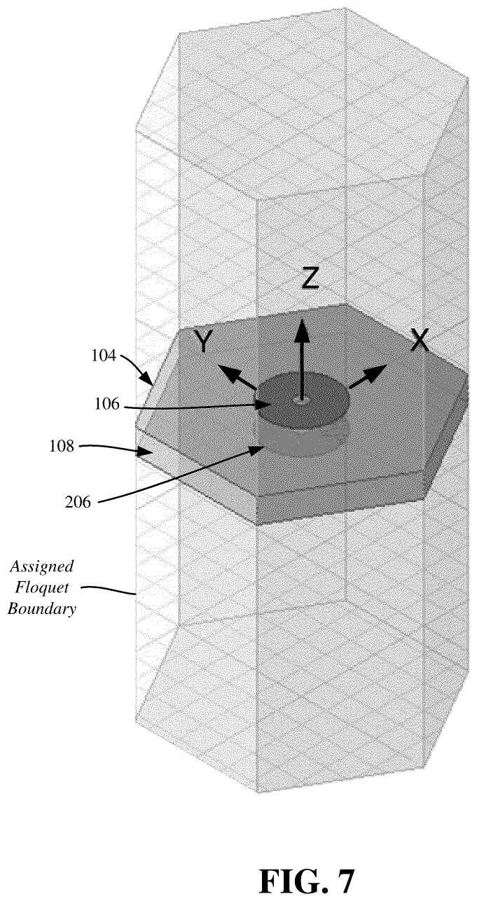

Simulations prove that the varying permittivity offers change in the unit-cell phase to achieve tunability based on a unit-cell simulated in ANSYS HFSS with a Floquet boundary assigned in HFSS as shown in FIG. 7.

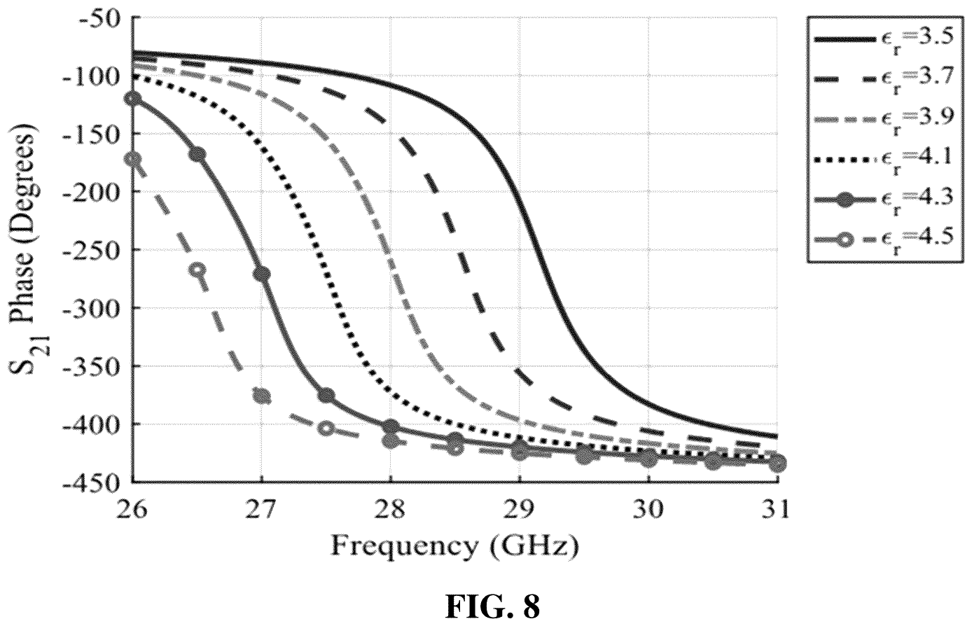

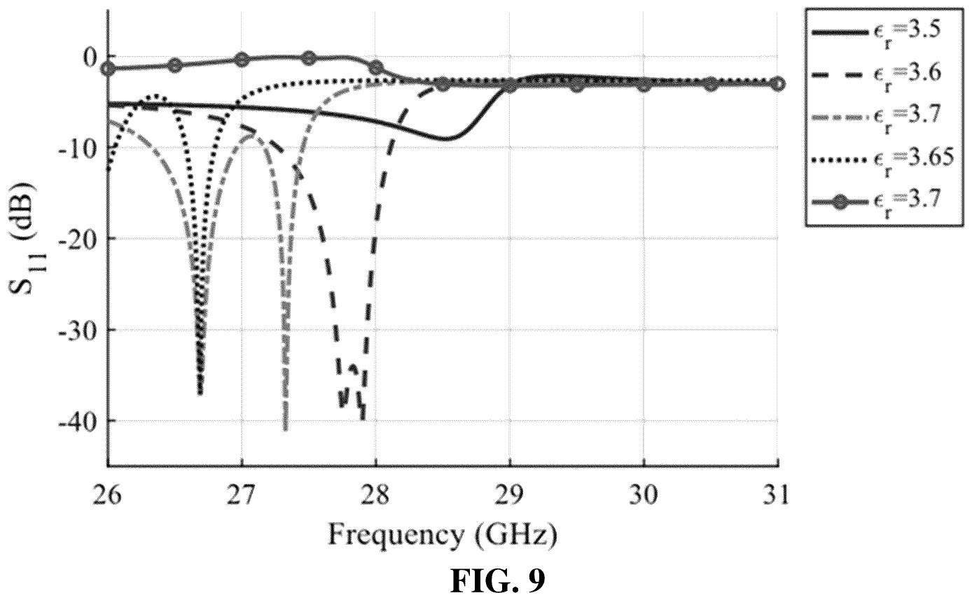

FIGS. 8 and 9 show results of simulation of the metasurface using the example unit cell of FIG. 7, in which the transmission phase of the waves appearing on the other side of the unit cell as a function of the dielectric's permittivity (and thus the refractive index). A gradual change in the phase is clear with a large phase range (i.e., greater than 360 degrees) as generally shown in FIG. 8. This is accompanied by a large transmission (and corresponding low reflection) across the surfaces, which is desired, as shown in FIG. 9. In particular, the Huygen's response is maintained as the permittivity is changed, and a good matching is achieved, provided a suitable operating frequency is chosen.

One or more example embodiments can be embodied in a unit cell, such as described and represented herein. The unit cell can include an upper metallic resonator, a lower metallic resonator, and a dielectric material between the upper metallic resonator and the lower metallic resonator. The upper metallic resonator and the lower metallic resonator can be configured to resonate based on a frequency of an impinging electromagnetic beam to refract an instance of the impinging electromagnetic beam in a refraction direction, resulting in a refracted instance. The refraction direction can be tunable based on an external stimulus applied to the unit cell.

The external stimulus can be applicable to the dielectric material to change a refractive index of the dielectric material.

The external stimulus can include heat applied to the dielectric material.

The external stimulus can include a mechanical force that changes stress or strain of the dielectric material.

The external stimulus can include electrical current applied to the dielectric material.

The dielectric material can be optically active, and the external stimulus can include light applied to the dielectric material.

The external stimulus can include electrical current applied to the upper metallic resonator.

The unit cell can be coupled to electrical bias lines.

The unit cell can be substantially transparent to light.

The unit cell can be part of a metasurface of unit cells including the unit cell and a group of other unit cells.

The refracted instance of the impinging electromagnetic beam can constructively interfere with respective other refracted instances of respective other unit cells of the group of other unit cells, to result in constructive interference that beamforms a beamformed beam reflected from the metasurface based on the impinging electromagnetic beam.

The frequency of the impinging electromagnetic beam can be within the millimeter wave frequency spectrum.

The dielectric material can be hexagonally shaped.

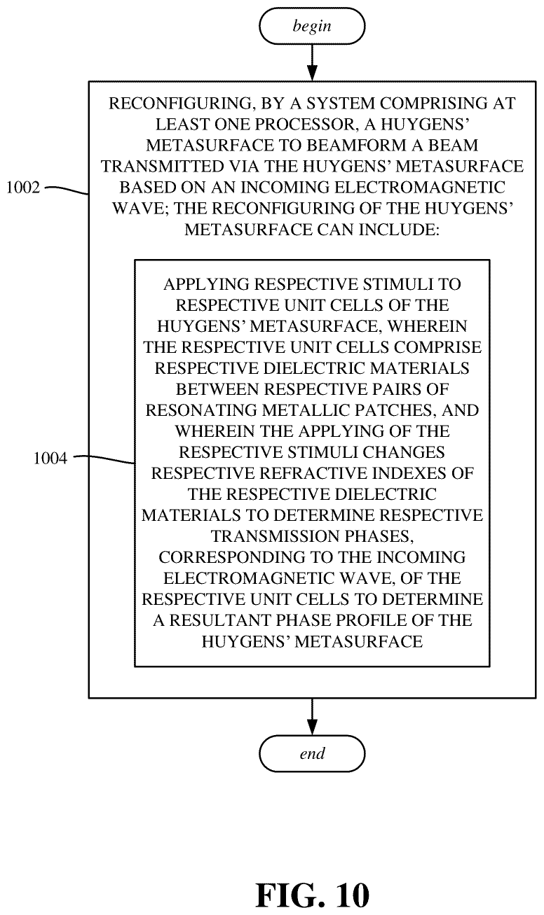

One or more example implementations and embodiments, such as corresponding to example operations of a method, can be represented in FIG. 10. Example operation 1002 represents reconfiguring, by a system comprising at least one processor, a Huygens' metasurface to beamform a beam transmitted via the Huygens' metasurface based on an incoming electromagnetic wave. The reconfiguring of the Huygens' metasurface can include example operation 1004, which represents applying respective stimuli to respective unit cells of the Huygens' metasurface, wherein the respective unit cells can include respective dielectric materials between respective pairs of resonating metallic patches, and wherein the applying of the respective stimuli changes respective refractive indexes of the respective dielectric materials to determine respective transmission phases, corresponding to the incoming electromagnetic wave, of the respective unit cells to determine a resultant phase profile of the Huygens' metasurface.

Applying the respective stimuli can include applying respective thermal energies to the respective dielectric materials to change respective permittivities of the respective dielectric materials.

Applying the respective stimuli can include applying respective electrical energies to the respective dielectric materials to change respective permittivities of the respective dielectric materials.

Applying the respective stimuli can include applying respective mechanical forces to the respective dielectric materials to change respective permittivities of the respective dielectric materials.

One or more example embodiments can be embodied in a metasurface, such as described and represented herein. The metasurface can include an array of unit cells arranged to transmit a beamformed instance of an electromagnetic wave impinging on the metasurface, the array of unit cells including a subarray including at least some of the unit cells. The subarray of the at least some of the unit cells can include a first unit cell, including a first upper metallic resonator, a first dielectric material below the first metallic resonator, and a first lower metallic resonator below the first dielectric material. The subarray can include a second unit cell, including a second upper metallic resonator, a second dielectric material below the first metallic resonator, and a second lower metallic resonator below the first dielectric material. A first phase response of the first unit cell can be controllable, based on applying a first stimulus to the first dielectric material to determine a first refractive index of the first dielectric material, to cause the first unit cell to transmit a first instance of a first portion of the beamformed instance in a first direction based on the first refractive index. A second phase response of the second unit cell can be controllable, based on applying a second stimulus to the second dielectric material to determine a second refractive index of the second dielectric material, to cause the second unit cell to transmit a second instance of a second portion of the beamformed instance in a second direction based on the second refractive index. The first portion of the beamformed instance transmitted in the first direction and the second portion of the beamformed instance transmitted in the second direction can constructively interfere as part of the beamformed instance.

The first stimulus can include at least one of: thermal energy, electrical energy, mechanical energy, or light energy.

The subarray can be substantially transparent to light.

As can be seen, described herein is a Huygens' metasurface with dynamic material tuning capability using permittivity changes. The metasurface is practical to implement and facilitates significant advancements in wireless communication systems. The metasurface achieves a wide phase range, based on a unit-cell design with a dielectric capable of changing its refractive index based on external stimuli. The metasurface can be optically transparent.

What has been described herein includes mere examples. It is, of course, not possible to describe every conceivable combination of components, materials or the like for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A unit cell, comprising:
an upper metallic resonator;
a lower metallic resonator; and
a dielectric material between the upper metallic resonator and the lower metallic resonator,
wherein the upper metallic resonator and the lower metallic resonator are configured to resonate based on a frequency of an impinging electromagnetic beam to refract an instance of the impinging electromagnetic beam in a refraction direction, resulting in a refracted instance, and
wherein the refraction direction is tunable based on an external stimulus applied to the unit cell.

2. The unit cell of claim 1, wherein the external stimulus is applicable to the dielectric material to change a refractive index of the dielectric material.

3. The unit cell of claim 2, wherein the external stimulus comprises heat applied to the dielectric material.

4. The unit cell of claim 2, wherein the external stimulus comprises a mechanical force that changes stress or strain of the dielectric material.

5. The unit cell of claim 2, wherein the external stimulus comprises electrical current applied to the dielectric material.

6. The unit cell of claim 2, wherein the dielectric material is optically active, and wherein the external stimulus comprises light applied to the dielectric material.

7. The unit cell of claim 1, wherein the external stimulus comprises electrical current applied to the upper metallic resonator.

8. The unit cell of claim 1, further comprising electrical bias lines for applying the electrical current to the unit cell.

9. The unit cell of claim 1, wherein the unit cell is substantially transparent to light.

10. The unit cell of claim 1, wherein the unit cell is part of a metasurface of unit cells comprising the unit cell and a group of other unit cells.

11. The unit cell of claim 1, wherein the refracted instance of the impinging electromagnetic beam constructively interferes with respective other refracted instances of respective other unit cells of the group of other unit cells, to result in constructive interference that beamforms a beamformed beam reflected from the metasurface based on the impinging electromagnetic beam.

12. The unit cell of claim 1, wherein the frequency of the impinging electromagnetic beam is within a millimeter wave frequency spectrum.

13. The unit cell of claim 1, wherein the dielectric material is hexagonally shaped.

14. A method, comprising:
reconfiguring, by a system comprising at least one processor, a Huygens' metasurface to beamform a beam transmitted via the Huygens' metasurface based on an incoming electromagnetic wave, the reconfiguring of the Huygens' metasurface comprising:
applying respective stimuli to respective unit cells of the Huygens' metasurface, wherein the respective unit cells comprise respective dielectric materials between respective pairs of resonating metallic patches, and wherein the applying of the respective stimuli changes respective refractive indexes of the respective dielectric materials to determine respective transmission phases, corresponding to the incoming electromagnetic wave, of the respective unit cells to determine a resultant phase profile of the Huygens' metasurface.

15. The method of claim 14, wherein the applying of the respective stimuli comprises applying respective thermal energies to the respective dielectric materials to change respective permittivities of the respective dielectric materials.

16. The method of claim 14, wherein the applying of the respective stimuli comprises applying respective electrical energies to the respective dielectric materials to change respective permittivities of the respective dielectric materials.

17. The method of claim 14, wherein the applying of the respective stimuli comprises applying respective mechanical forces to the respective dielectric materials to change respective permittivities of the respective dielectric materials.

18. A metasurface, comprising:
an array of unit cells arranged to transmit a beamformed instance of an electromagnetic wave impinging on the metasurface, the array of unit cells comprising a subarray comprising at least some of the unit cells, the subarray of the at least some of the unit cells comprising:
a first unit cell, comprising:
a first upper metallic resonator,
a first dielectric material below the first metallic resonator, and
a first lower metallic resonator below the first dielectric material; and
a second unit cell, comprising:
a second upper metallic resonator,
a second dielectric material below the first metallic resonator, and
a second lower metallic resonator below the first dielectric material,
wherein a first phase response of the first unit cell is controllable, based on applying a first stimulus to the first dielectric material to determine a first refractive index of the first dielectric material, to cause the first unit cell to transmit a first instance of a first portion of the beamformed instance in a first direction based on the first refractive index;
wherein a second phase response of the second unit cell is controllable, based on applying a second stimulus to the second dielectric material to determine a second refractive index of the second dielectric material, to cause the second unit cell to transmit a second instance of a second portion of the beamformed instance in a second direction based on the second refractive index, and
wherein the first portion of the beamformed instance transmitted in the first direction and the second portion of the beamformed instance transmitted in the second direction constructively interfere as part of the beamformed instance.

19. The metasurface of claim 18, wherein the first stimulus comprises at least one of: thermal energy, electrical energy, mechanical energy, or light energy.

20. The metasurface of claim 18, wherein the subarray is substantially transparent to light.
